(19) United States
(12) Patent Application Publication
(10) Pub. No.: US 2026/0318329 A1
(43) Pub. Date: Oct. 15, 2026

(54) CUSTOMIZABLE FORCE APPLICATION DEVICE

(71) Applicant: Dean Golub, Chicago, IL (US)

(72) Inventor: Dean Golub, Chicago, IL (US)

(21) Appl. No.: 19/177,746

(22) Filed: Apr. 14, 2025

(51) Int. Cl. F15B 15/20; B30B 15/18

(52) U.S. Cl. CPC F15B 15/20; B30B 15/18

(57) ABSTRACT

A device for applying force to various pieces. A device which is customizable to apply varying force to at least one piece. A device which consists of at least one housing, one force generator, one force transfer, one force opposition, and one movement limit, all having attachment points spaced apart in a standardized pattern. A device housing which can have various members which combine to provide attachment locations for: force generator(s), force opposition(s), movement limit(s), force transfer(s), workpiece retainer(s), safety device(s), control device(s), and indicator(s). Complex interactions between force generation, force transfer, force opposition, and housing can be established using various: force transfer, force opposition, and retention members which combine to perform a vast variety of actions to work piece(s). Force transfer(s), force opposition(s), safety member(s), and retention member(s) can be directly, indirectly, immovably, and movably attached to each other and housing members.

### BACKGROUND

The present disclosure generally relates to the application of force to workpieces; particularly hydraulic presses and pullers, and a method of use and manufacture of such a press and puller, are provided.

A vast majority of force application devices contemporarily in use are similar in design and functionality; however, these devices have disadvantages:
(a) They typically do not apply force simultaneously to multiple workpieces.
(b) They typically are confined with regard to the shapes and sizes of workpieces they can apply force to.
(d) They typically are confined with regard to the maximum force they can apply.
(e) They typically cannot be configured to disperse a maximum force over a time span.
(f) There is no standardization of members between them.

### SUMMARY

In accordance with one embodiment, a force application device comprises: a housing having interchangeable members which provide standardized mounting points for at least one: force generator, force transfer, force opposition, and safety mechanism.

Accordingly, advantages of one or more aspects are as follows: to provide a device which: enables manufacture and use of standardized members which facilitate application of force to ubiquitous workpieces simultaneously, can be configured to apply various forces to workpieces of numerous shapes and sizes, is mobile, and is safe. The present subject matter will be referred to as “the invention”.

### BRIEF DESCRIPTION OF DRAWINGS

FIG. 1 Shows a perspective view of a force application device.

FIG. 2 Shows an elevation view of a: force generator, force transfer platform, and limit.

FIG. 3 Shows an elevation view of two states of a limit.

FIG. 4 Shows an elevation view of interaction between a: force transfer member, cam, and retainer in a retracted position.

FIG. 5 Shows an elevation view of interaction between a: force transfer member in a partially extended position, cam, and retainer.

FIG. 6 Shows an elevation view of interaction between a: force transfer member in a fully extended position, cam, and retainer.

FIG. 7 Shows a perspective view of three cammed force transfer members in differing states of interaction with: retainers, and workpiece during a separation application of force.

FIG. 8 Shows a perspective view of a: force transfer member, workpieces and force opposition member during a pressing application of force which assembles said workpiece.

FIG. 9 Shows a perspective view of: two force transfer members, a workpiece, and force opposition member during a pressing application of force which bends said workpiece.

FIG. 10 Shows an elevation view of a housing 1, safety shield 14, and limit 9.

### REFERENCE NUMERALS AND DEFINITIONS

1 Housing A framework of interchangeable, attachable members which provide standardized attachment points.
2 Force Generator A removably attachable device which generates force
3 Force Transfer Platform A removably attachable, force transferring platform to which other members can be removably attached.
4 Force Opposition Platform A removably attachable, force opposing platform to which other members can be removably attached.
5 Force Transfer Member A removably attachable, force transferring member to which other members can be removably attached.
6 Force Opposition Member A removably attachable, force opposing member to which other members can be removably attached.
7 Retainer A movable object which temporarily engages and fixes another object in a certain position.
8 Cam An object which uses movement to guide other objects.
9 Limit A motion control device.
10 Actuator A motion control device which initiates action.
11 Workpiece An object to which force is applied causing change to said object.
12 Rotation Location Center of a circle.
13 Guide Object which guides other objects during movement.
14 Safety Shield A device which shields users from potentially dangerous events.

### DETAILED DESCRIPTION

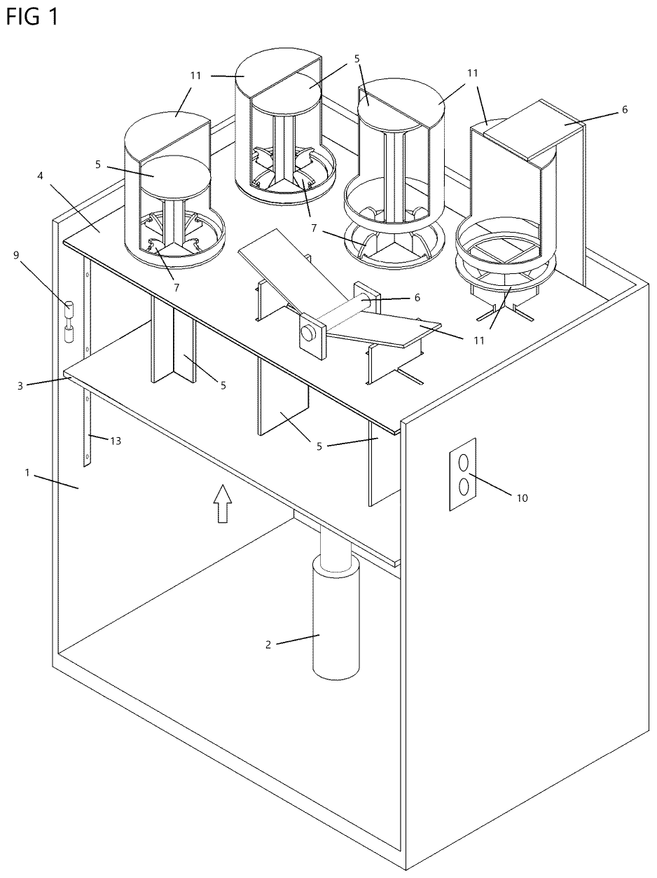

FIG. 1 shows a perspective view of one embodiment of a force application device. Housing 1 consists of vertical and horizontal members. The housing 1 members shown in FIG. 1 are a horizontal floor member, two vertical side members, and one vertical rear member. Housing 1 members are removably attachable to other housing 1 members. Housing 1 members have attachment points which are spaced at standard distances apart. This standardized spacing of attachment points enables housing 1 members; to attach to each other in numerous configurations, be of differing dimensions, and accept attachment of various objects to various attachment points. Plastic building block toys have numerous members which removably attach to each other using standardized attachment points. Housing 1 provides a framework to build numerous assemblies similarly to the way plastic building block toys can.

The current embodiment shows various members attached to a housing 1. The arrow indicates upward directional movement of force transfer platform 3. Force generator 2; a hydraulic cylinder in this case, is simultaneously attached to a horizontal floor member of housing 1, and a force application platform 3, which provides push or pull force between them. In relation to other members; vertical movement of force transfer platform 3 follows at least one guide 13. Force transfer platform 4 can engage a limit 9 which terminates part of a movement cycle of the invention, and initiates another part of said movement cycle. Movement cycles can be initiated by actuator 10.

At least one force transfer member 5 is attached to force transfer platform 3, and traverse through openings in force opposition platform 4. Force opposition platform 4 is removably attached to housing 1, and fixed in a static position in relative to housing 1. Force opposition members 6 can be removably attached to force opposition platform 4 and housing 1. FIG. 1 shows the simultaneous application of force to multiple, differently shaped instances of workpiece 11.

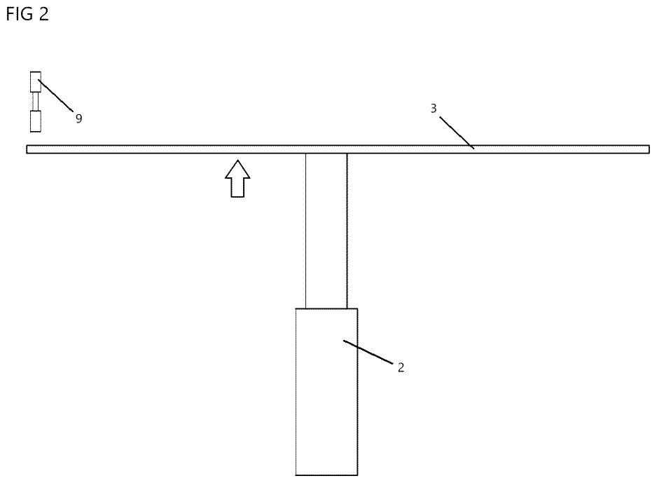

FIG. 2 Shows an elevation view one embodiment of: a force generator 2, a force transfer platform 3, and a limit 9. The arrow shows upward vertical direction. Force generator 2 is a member which provides push or pull force. The force generator 2 depicted is a hydraulic cylinder which has an outer sleeve of a larger diameter than an encased inner sleeve. Usually, a hydraulic cylinder has fluid pumped into, and evacuated from it by an electrically powered pump. At least one force generator 2 can urge force transfer platform 3 in an upward direction which eventually engages a limit 9, or a downward direction which engages a limit 9 not depicted.

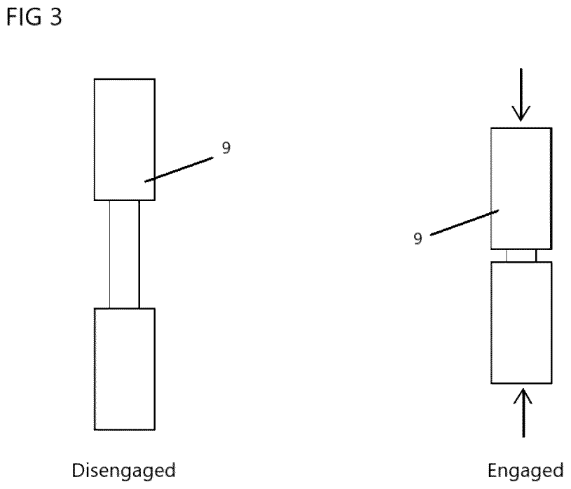

FIG. 3 Shows an elevation view of two states of a limit 9 embodiment. Limit 9 is a component of electrical circuitry which alters electrical current, and initiates part of an electrical cycle. Limit 9 is a motion control device. Disengaged shows a limit 9 which is not engaged by another object. Engages shows an engaged limit 9 which is temporarily deformed. Engaging a limit 9 causes internal electrical contacts to complete, or disrupt an electrical circuit. A limit 9 can be configured to stop movement of other members at specific locations which facilitates repetitive workpiece force application capability. The invention can be disabled when a safety shield 14 and limit 9 are disengaged. At least one indicator can be enabled or disabled by a limit 9. A second embodiment of a limit 9 would be a timer which can acuate or stop movement of other members at a set schedule.

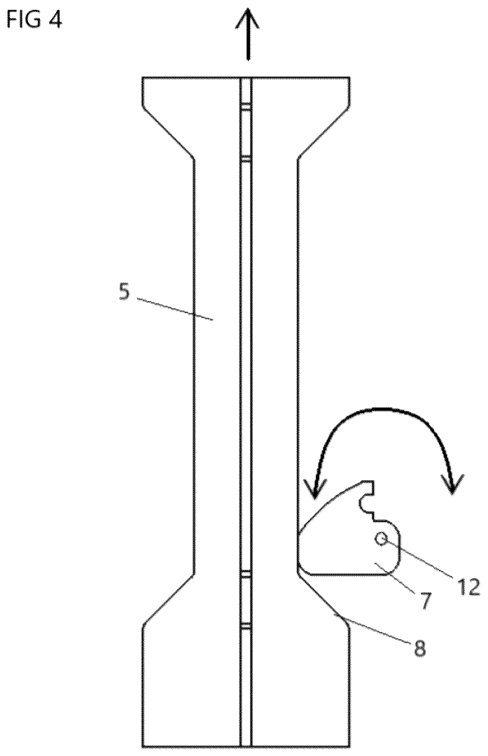

FIG. 4 Shows an elevation view of one embodiment of a force transfer 5. The arrow indicates direction of movement of force transfer 5. FIG. 4 shows how a moving force transfer 5 in the direction of the arrow would cause cam 8 to engage retainer 7 which rotates about rotation location 12.

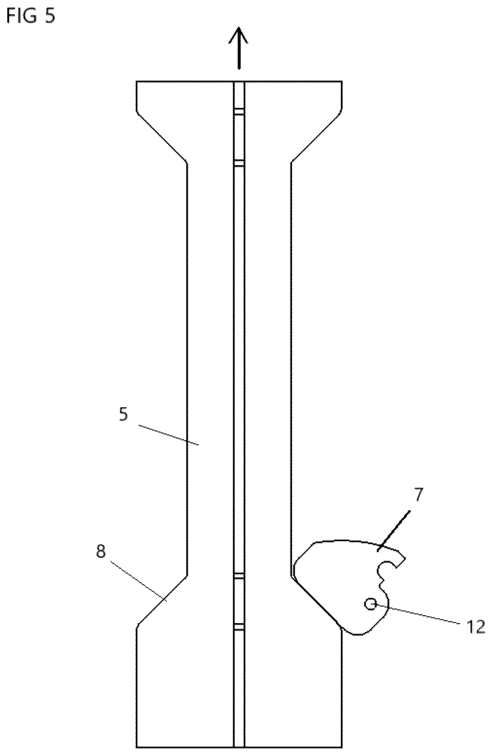

FIG. 5 Shows an elevation view of one embodiment of a force transfer 5. The arrow indicates direction of movement of force transfer 5. FIG. 5 shows the engagement of cam 8 and rotated retainer 7 after partial movement of force transfer 5.

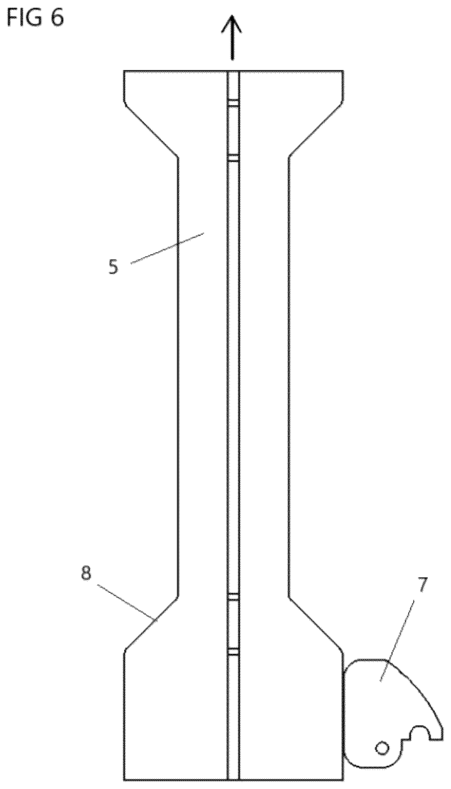

FIG. 6 Shows an elevation view of one embodiment of a force transfer 5. The arrow indicates direction of movement of force transfer 5. FIG. 6 shows the engagement of cam 8 and rotated retainer 7 after completed movement of force transfer 5. Numerous other embodiments of force transfer 5 are possible to customize application of force.

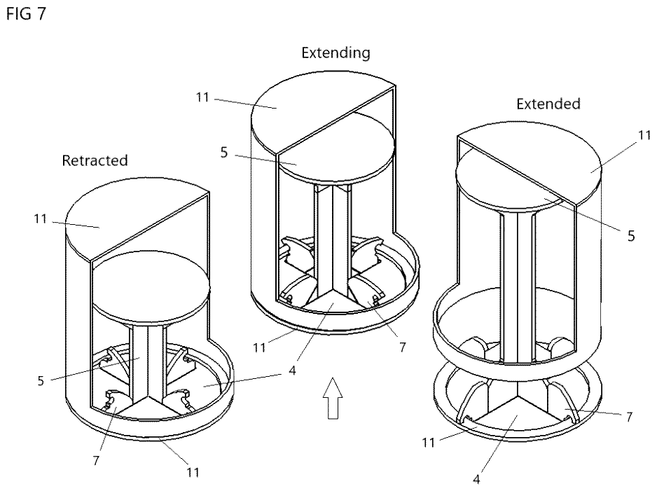

FIG. 7 Shows a perspective view of three instances of one embodiment of force transfer 5 in differing states of engagement with other members. The arrow indicates upward movement of force transfer 5. At least one retainer 7 is rotatably attached to force opposition platform 4. Retracted instance shows an upward moving force transfer member 5 which has not yet engaged other members. Extending instance shows at least one cam 8 of an upward moving force transfer member 5 engaging and rotating at least one retainer 7. Extended instance shows a force transfer member 5 which has engaged, and separated workpiece 11. FIG. 7 demonstrates a method for load dispersal. FIG. 7 shows sequential engagement between three instances of force transfer 5 and three instances of workpiece 11. The maximum momentary force of a sequential engagement cycle is less than the maximum momentary force the same cycle with one simultaneous engagement. The invention can disperse loads by staggering engagement times which facilitates conservation of materials and energy.

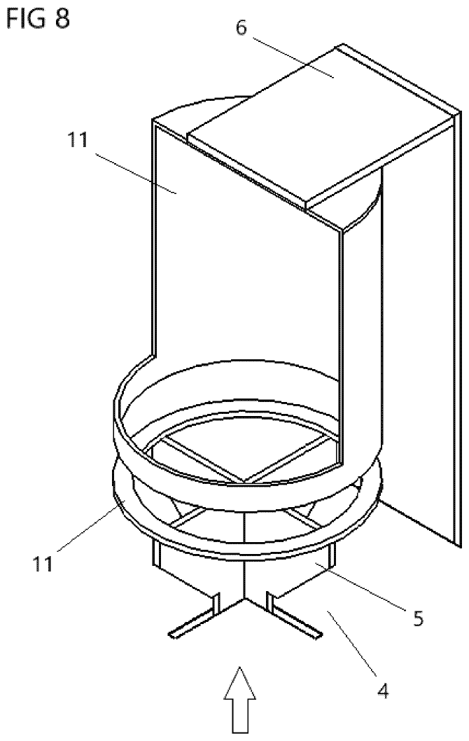

FIG. 8 Shows a perspective view of one embodiment of a force transfer 5 engaging other members. The arrow indicates upward movement of force transfer 5. A workpiece 11 can be attached to another workpiece 11 by; fixing one workpiece 11 to a force opposition member 6, fixing another workpiece 11 to a force transfer member 5, and merging said workpieces together using the upward movement of force transfer member 5.

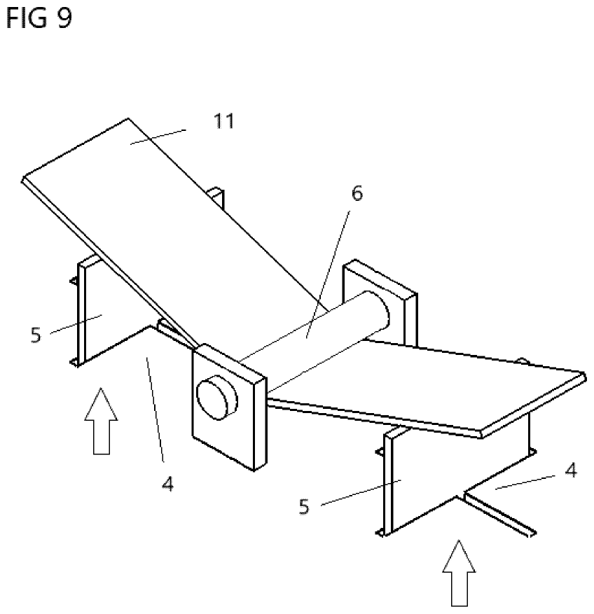

FIG. 9 Shows a perspective view of an embodiment of two instances of force transfer 5 engaging other members. The arrow indicates upward movement of each force transfer 5. A workpiece 11 can be positioned between force opposition platform 4 and a force opposition member 6. Simultaneous upward movement of each force transfer member 5 causes engagement of workpiece 11 with force opposition member 6. Continuation of upward movement of each force transfer member 5 bends workpiece 11.

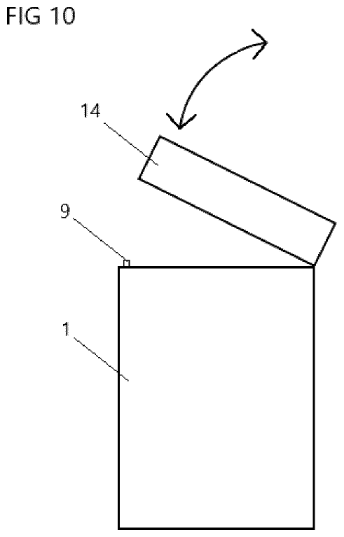

FIG. 10 Shows an elevation view of a housing 1, limit 9, and safety shield 14. The arrows indicate rotational movement. Shield 14 can engage or disengage at least one limit 9 which disables the device until shield 14 is in a position to protect a user from injury.

Manner of use for an embodiment the invention can consist of:
(a) assembly of pre-manufactured housing 1 members which support a certain maximum force.
(b) attachment of a pre-manufactured set of: force generator(s), force transfer member(s), force opposition member(s), and limit(s) to standardized attachment points.
(c) ordering and using pre-manufactured sets of: force transfer member(s), force opposition member(s), and limit(s) in accordance with a variety of force applications.
(d) reconfiguring the invention as desired.
(e) designing, creating, and manufacturing new and unique sets of members which utilize the standardized attachment points of the invention.

Manner of manufacture for an embodiment of the invention can consist of:
(a) design and manufacture of different sets of housing 1 members in accordance with maximum forces necessary, area said forces are applied to, and standardized attachment points.
(b) design and manufacture of different sets of: force transfer member(s), force opposition member(s), safety shield(s), and limit(s) in accordance with the aforementioned housing 1 assemblies, and workpiece requirements.

From the description above, a number advantages of some embodiments of the invention become evident:
(a) use of an embodiment enables users to conserve resources and time in relation to a force application device which cannot be configured and configured.
(b) members of an embodiment can be mass produced to facilitate common applications of force.
(c) an embodiment facilitates simultaneous application of force.
(d) an embodiment can be repetitively configured to apply force differently each conversion.
(e) an embodiment enables customization by users.

1. A force application device comprising:
(a) at least one housing,
(b) at least one force generator,
(c) at least one force transfer member,
(d) at least one force opposition member,
(e) at least one motion control,
(f) at least one safety member,
(g) standardized attachment locations to which members can interchangeably, movably, and removably attach,
whereby said force application device provides customizability with regard to the application of force to a variety of singular or multiple workpieces, simultaneously or sequentially.
